(19) United States
(12) Patent Application Publication
(10) Pub. No.: US 2004/0004807 A1
(43) Pub. Date: Jan. 8, 2004

(54) Combined microwave oven and radio

(75) Inventors: Ji Woong Kim, Pusan-kwangyok-shi (KR); Kyung Hwan Choi, Changwon-shi (KR)

Correspondence Address: FLESHNER & KIM, P.O. Box 221200, Chantilly, VA, 20153-1200, US

(73) Assignee: LG Electronics Inc.

(21) Appl. No.: 10/412,324

(22) Filed: Apr. 14, 2003

(30) Foreign Application Priority Data
Jul. 2, 2002 (KR) P 2002-38058
Jul. 2, 2002 (KR) P 2002-38059

(51) Int. Cl. H02B 1/00

(52) U.S. Cl. 361/600; 700/17

(57) ABSTRACT

Embodiments of the present invention relate to an apparatus including both an oven (i.e. a microwave oven) and a radio. In embodiments of the present invention, control circuitry is shared for both the oven and the radio. Embodiments of the present invention are advantageous, as a consumer desiring both a microwave oven and a radio need not buy these devices separately because they are combined in a single combination unit. The present invention is also advantageous, as the combination microwave oven and radio is less costly to produce than an oven and a radio that are separate devices. This is possible because many components (i.e. the casing and/or control circuitry) are shared between the two devices. Accordingly, a combination oven and radio may be more affordable to consumers.

### BACKGROUND OF THE INVENTION

1. Field of the Invention

The present invention generally relates to microwave ovens and radios.

2. Background of the Related Art

Electronic devices are a part of many people's everyday lives. Examples of electronics are televisions, radios, computers, fans, telephones, lamps, and microwave ovens. As the amount of devices available to consumers increases, consumers may have difficulty accommodating many different electronic devices. However, consumers may not want to give up the benefit they receive from all the different electronic devices due to limited space in their dwellings. Accordingly, there has been a long felt need to maintain the services of the plurality of different electronic devices and at the same time minimize the amount of space these electronic devices consume. Additionally, there has been a long felt need for the price of consumer devices to be minimized.

### SUMMARY OF THE INVENTION

Embodiments of the present invention relate to an apparatus including both an oven (i.e. a microwave oven) and a radio. In embodiments of the present invention, control circuitry is shared for both the oven and the radio. Embodiments of the present invention are advantageous, as a consumer desiring both a microwave oven and a radio need not buy these devices separately because they are combined in a single combination unit. The present invention is also advantageous, as the combination microwave oven and radio is less costly to produce than an oven and a radio that are separate devices. This is possible because many components (i.e. the casing and/or control circuitry) are shared between the two devices. Accordingly, a combination oven and radio may be more affordable to consumers.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

FIG. 1 is an exemplary block diagram illustrating the construction of a microwave oven.

FIG. 2 is an exemplary block diagram illustrating the construction of a radio and microwave oven.

FIG. 3 is an exemplary view illustrating various kinds of key buttons provided on a microwave oven.

FIG. 4 is an exemplary flowchart illustrating an exemplary process of storing radio frequencies in an EEPROM in a microwave oven.

FIG. 5 is an exemplary flowchart illustrating an exemplary process of receiving a radio signal using frequencies stored in an EEPROM in a microwave oven.

FIG. 6 is an exemplary flowchart illustrating an exemplary process of checking and storing a selection frequency of a selected frequency in a microwave oven.

FIG. 7 is an exemplary flowchart illustrating a control process so that use information of radio frequencies is displayed on a display device of a microwave oven.

### DETAILED DESCRIPTION OF PREFERRED EMBODIMENTS

Embodiments of the present invention relate to a microwave oven. A microwave oven is a cooking appliance that may cook in a simple and rapid manner using microwaves and heat generated from a heater.

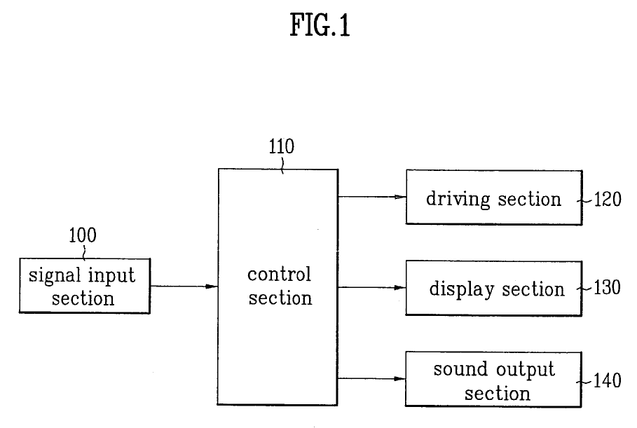

FIG. 1 is an exemplary block diagram illustration of a microwave oven. A microwave oven may include driving section 120, control section 110, signal input section 100, display section 130, and/or sound output section 140. Driving section 120 may include a magnetron, a heater, and/or another component that may be for generating microwaves and heat for cooling. Control section 110 may be for controlling driving section 120. Signal input section 100 may be for selecting or inputting a cooking mode. Display section 130 may be for displaying a cooking state and/or a user's input. Sound output section 140 may be for outputting sound that may be for sending an indication to a user.

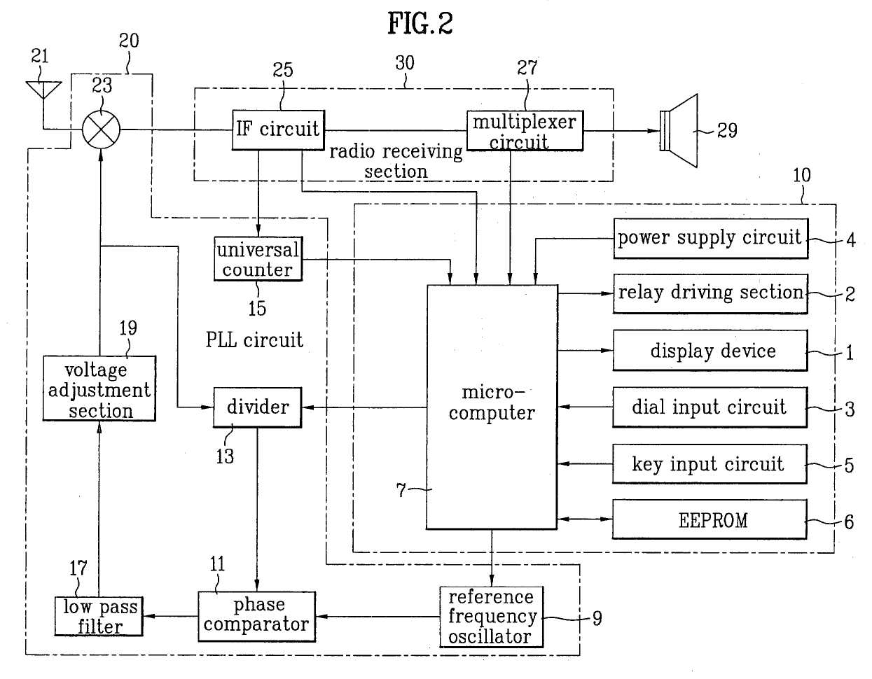

FIG. 2 is an exemplary block diagram illustrating a radio/microwave oven according to embodiments of the present invention. In embodiments, a radio/microwave oven comprises radio modules (20 and 30) and driving module 10. Radio modules (20 and 30) may be for a radio function of a radio/microwave oven. Driving module 10 may be a controller of a radio/microwave oven. Radio modules 20 and 30 may be controlled through driving module 10 of a microwave oven.

Radio modules 20 and 30 may include antenna 21, phase locked loop (PLL) circuit 20, and/or radio receiving section 30. Antenna 21 may be for receiving a radio signal. PLL circuit 20 may be for converting a signal received from antenna 21 into an intermediate frequency signal according to a PLL system. Radio receiving section 30 may be for amplifying a signal of a desired band from an intermediate frequency signal, processing, and/or outputting an amplified signal. A radio/microwave oven may also include speaker 29 for amplifying an output signal of radio receiving section 30 so that sound can be heard by a user.

Driving module 10 may include relay driving section 9, dial input circuit 3, key input circuit 5, display device 1, and/or microcomputer 7. Relay driving section 2 may be for driving a magnetron, a heater, and/or a fan motor when cooking in a microwave oven. Dial input circuit 3 and key input circuit 5 may be signal input sections that may be for inputting a user's selection signal. Display device 1 may be for displaying an operation state of a microwave oven and/or a user's input signal. Microcomputer 7, which may be connected to radio modules 20 and 30, may be for controlling radio modules 20 and 30 so that radio module 20 and 30 can receive a radio signal selected by a user without noise. Microcomputer 7 may be connected to driving module 10. Microcomputer 7 may control driving module 10 in order to control menu selection (i.e. automatic cooking mode, manual cooking mode, a time period automatically or manually set according to the selected menu, a temperature, a proceeding state, etc.).

Driving module 10 of a microwave oven may include a power supply circuit 4 that may be for supplying power to respective components of microwave oven driving module 10. Dial input circuit 3 may be for inputting signals that change according to a rotating amount of a dial. Dial input circuit 3 may be used as an input of a menu program (i.e. automatic cooking, time period, temperature, etc.). Key input circuit 5 may select various kinds of key signals provided on an external case of a microwave oven and transmit corresponding codes of the selected key signals to microcomputer 7. Dial input circuit 3 and key input circuit 5 may be used as an input interface for channel selection when a radio function of a radio/microwave oven is used. Dial input circuit 3 and key input circuit 5 may include buttons for selecting radio channels.

Relay driving section 2 may include relays (not illustrated) for providing/intercepting a power supply to/from a magnetron and/or heater. A magnetron (not illustrated) may be for generating microwaves for cooking. A heater may be for generating heat for cooking. Relay driving section 2 may include relays (not illustrated) for connecting/intercepting a power supply to/from a fan motor that circulates air during a cooling and heating operation.

Microcomputer 7 may control components of a microwave oven in order to control a cooking operation of the microwave oven. Microcomputer 7 may store control algorithms for cooking control. For example, microcomputer 7 may store a control algorithm according to a control process (i.e. an operating temperature, an operating time, etc.) for respective cooking menu items. Microcomputer 7 may be for control of radio functions. Microcomputer 7 may recognize a frequency of a broadcasting channel currently received by a radio receiving section 30 and/or check if the frequency of the received broadcasting channel coincides with that of the broadcasting channel selected by a user. If they do not coincide, microcomputer 7 may tune a frequency of a received broadcasting channel to that of a broadcasting channel selected by the user by repeatedly controlling PLL circuit 20. Microcomputer 7 may include a control algorithm for radio function control.

Display device 1 may receive a signal from microcomputer 7 to display information (i.e. cooking state, selected cooking mode, etc.) during performance of a function of a microwave oven. During performance of radio functions, display device 1 may display a frequency of a channel selected by a user (i.e. present input frequency according to the tuning operation, finally confirmed frequency, etc.).

PLL circuit 20 may be connected to an internal serial port of microcomputer 7. Elements of PLL circuit 20 may be implemented in a serial manner and data inputted into PLL circuit 20 is serial data. PLL circuit 20 may be an element for performing a tuning operation, receive a control signal from microcomputer 7, and/or tune a frequency of a received channel to that of a channel selected by a user.

PLL circuit 20 may include a reference frequency oscillator 9, a divider 13, a phase comparator 11, a low pass filter 17, a voltage adjustment section 19, a universal counter 15, and/or a mixer 23. Reference frequency oscillator 9 may be for oscillating a reference frequency for tuning to a desired frequency under the control of microcomputer 7. Divider 13 may be for dividing a frequency of an input signal under the control of the microcomputer 7. Phase comparator 11 may be for comparing phases of a frequency outputted from divider 13 and a reference frequency oscillated from reference frequency oscillator 9. Low pass filter 17 may be for outputting a DC voltage corresponding to a phase difference between two frequencies. Voltage adjustment section 19 may be for outputting an oscillation frequency f₀ according to a DC voltage output from low pass filter 17 (e.g., an oscillation frequency f₀ determined by tuning data from microcomputer 7). Mixer 23 may be for mixing oscillation frequency f₀ and a signal received through antenna 21. Radio receiving section 30 may include an intermediate frequency circuit and/or a multiplexer circuit 27. Intermediate frequency circuit 25 may be for amplifying a signal of a desired band from an output signal of mixer 23. Multiplexer circuit 27 may be for converting an output of intermediate frequency circuit 25 into a stereo sound and outputting stereo sound to speaker 29.

Output of voltage adjustment section 19 may be repeatedly fed to divider 13, repeatedly until oscillation frequency f₀ is accurately tuned to a frequency of a selected channel. This repeated operation may be controlled by microcomputer 7. Microcomputer 7 may recognize and analyze input signals from intermediate frequency circuit 25 and multiplexer circuit 27. Microcomputer 7 may apply a control signal to divider 13 and reference frequency oscillator 9 according to results of recognition and analysis. For example, microcomputer 7 may control divider 13 to divide input signals into desired frequencies or may control reference frequency oscillator 9 to oscillate at a desired frequency. Microcomputer 7 may control a start and an end of operation of divider 13 and reference frequency oscillator 9.

PLL circuit 20 may include a universal counter 15. Universal counter 15 may count an intermediate frequency signal outputted from intermediate frequency circuit 25 and may output a result of the count to microcomputer 7. Microcomputer 7 may control display device 1 to display an output signal of universal counter 15.

Microcomputer 7, in driving module 10 of a microwave oven, may be connected to divider 13 and reference frequency oscillator 9 of PLL circuit 20 through an internal serial port. In order to receive an output signal of universal counter 15 in PLL circuit 20, microcomputer 7 may be connected to universal counter 15. Microcomputer 7 may be connected to an output terminal of intermediate frequency circuit 25 in radio receiving section 30 and to an output terminal of multiplexer circuit 27.

Power inputted to a microwave oven may be supplied to microcomputer 7 through power supply circuit 4 for a cooking operation. Power from power supply circuit 4 may be supplied to radio module 20 and 30 and driving module 10 of a microwave oven. When power is supplied inside a product, a user may select a cooking mode through dial input circuit 3 or key input circuit 5. A selected cooking mode may be inputted to microcomputer 7. Microcomputer 7 may control elements of driving module 10 of a microwave oven to perform a selected cooking operation.

If a selected cooking operation is an automatic cooking operation, then microcomputer 7 may recognize a predetermined control algorithm corresponding to a selected cooking mode. Microcomputer 7 may apply a control signal to relay driving section 2 to drive a corresponding driving device (i.e. a magnetron or a heater). Microcomputer 7 may output a signal to display device 1 to display a cooking state that may be presently proceeding. If a selected cooking operation is manual cooking, then microcomputer 7 may output a signal to display device 1 to display a value corresponding to a signal inputted by a user, and may apply a control signal for driving corresponding driving devices to perform a selected manual cooking operation. After a start of cooking, microcomputer 7 may control display device 1 to display data according to a cooking state that may be presently proceeding.

If a user intends to perform a radio function in a state that power is supplied from power supply circuit 4 to respective blocks, a user may select a desired radio channel using dial input circuit 3 or key input circuit 5. Information on a selected radio channel may be provided to microcomputer 7. Microcomputer 7 may recognize that a user requested a radio function and a radio channel desired by the user. According to a result of recognition, microcomputer 7 may output a control signal for listening to a radio to PLL circuit 20.

Microcomputer 7 may, when a radio microwave oven is turned on and a radio function is first selected, recognize a frequency of a radio channel to be tuned from channel information previously stored. PLL data may be for making a center frequency of a recognized radio channel output to divider 13. An operation signal may be output to reference frequency oscillator 9. Driving module 10 of a microwave oven may include an EEPROM for storing channel information. Divider 13 may divide a frequency fed back from voltage adjustment section 19 and may provide a divided frequency to phase comparator 11. Phase comparator 11 may receive a frequency divided by divider 13 and a reference frequency oscillated from reference frequency oscillator 9. Phase comparator 11 may compare the phases of the two frequencies.

Low pass filter 17 may generate a DC voltage corresponding to a phase difference between a frequency divided by divider 13 and a reference frequency oscillator 9. Low pass filter 17 may provide DC voltage to voltage adjustment section 19. Voltage adjustment section 19 may provide to mixer 23 oscillation frequency f₀ according to a DC voltage outputted from low pass filter 17 (i.e., oscillation frequency f₀ may be determined by tuning data of microcomputer 17).

Mixer 23 may mix a radio signal received through antenna 21 and oscillation frequency f0. Mixer 23 may output an intermediate frequency (IF) to radio receiving section 30. Intermediate frequency (IF) circuit 25 comprised in radio receiving section 30 may amplify a signal of a desired band from an input signal. Intermediate frequency (IF) circuit 25 may output a desired band signal. A signal outputted from IF circuit 25 may be inputted to universal counter 15. Universal counter 15 may numerate an input signal and provides a numerated signal to microcomputer 7.

Microcomputer 7 may control display device 1 to display an output signal of universal counter 15. Accordingly, a user may confirm a frequency of a selected channel according to a signal displayed on display device 1. An IF signal SD outputted from IF circuit 25 may be directly inputted to microcomputer 7. Microcomputer 7 may check whether a frequency of an inputted signal is identical to a frequency of a channel selected by a user. If it is checked that a frequency of a channel selected by a user is different from a signal SD directly inputted from IF circuit 25, microcomputer 7 may control PLL circuit 20 to repeatedly perform a tuning operation for a coincidence of two frequencies.

Microcomputer 7 may perform a process of re-checking a coincidence of two signals by comparing a signal ST directly inputted from multiplexer circuit 27 and a signal directly inputted from IF circuit 25. If a selection of a radio channel is completed through this process, display device 1 may display a user selected radio channel frequency counted by universal counter 15. A signal outputted from IF circuit 25 may become a signal of a radio channel selected by a user. Accordingly, multiplexer circuit 27 may convert an output signal of IF circuit 25 into stereo sound. Multiplexer circuit 27 may output stereo sound through speaker 29.

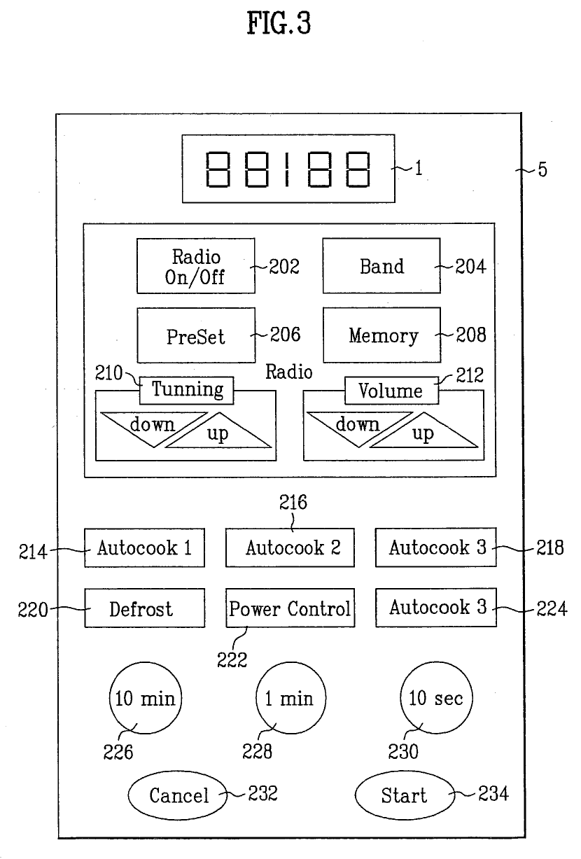

FIG. 3 is an exemplary view illustrating various kinds of key buttons provided in a microwave oven according to embodiments of the present invention. A radio microwave oven may include at least one of volume key 212 for volume adjustment, tuning key 210 for fine adjustment of a frequency band, band key 204 for rough adjustment of a frequency band, memory key 208 for storing frequency selection information, preset key 206 for selecting a desired frequency with reference to a frequency selection information uploaded from the EEPROM 6, and on/off key 202 for listening to a radio. Numeral ‘1’ denotes a display device. Frequency selection information may be a frequency list according to a number of selection, a frequency list of a specified number of frequencies predetermined by the user, and/or information on the frequency finally selected. One of ordinary skill in the art would appreciate that various kinds of key buttons for cooking operations of a microwave oven may be provided in addition to those described above.

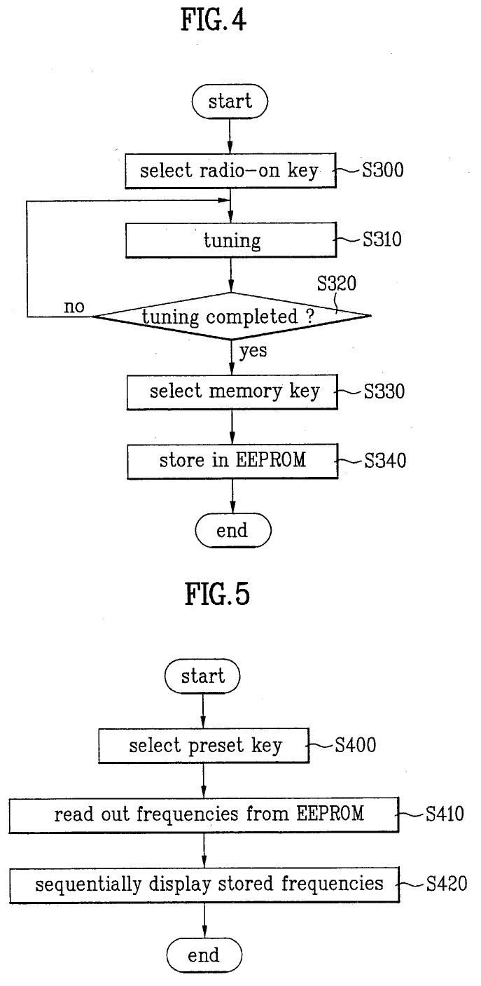

FIG. 4 is an exemplary flowchart illustrating a process of storing radio frequencies in an EEPROM in a microwave oven according to embodiments of the present invention. As illustrated in FIG. 2, embodiments of the present invention may include EEPROM 6 which may store select radio frequencies. EEPROM 6 may store selected frequencies under control of microcomputer 7. A user may select radio-on/off button 202 to listen to a radio (step S300). Accordingly, a specified signal corresponding to on/off button 202 may be inputted to microcomputer 7.

Microcomputer 7 may recognize that a user selected a radio function according to a signal. A user may select a frequency of a broadcasting channel using tuning key 210 (step S310). If a user selects memory key 208 after completion of a final selection (steps S320 and S330), microcomputer 7 may store a selected frequency in EEPROM 6 (step S340). Microcomputer 7 may include a frequency stored in EEPROM 6 in information for preset performing. This may be for reading out a frequency stored in EEPROM 6 when preset key 206 is selected. A user may store a plurality of frequencies in EEPROM 6 according to a preset function of microcomputer 7.

FIG. 5 is an exemplary flowchart illustrating a process of receiving a radio signal using frequencies stored in an EEPROM in a microwave oven according to embodiments of the present invention. A user may select radio-on key 202 if he/she intends to listen to a radio that is part of a microwave oven. A user may select preset key 206 (step S400). If preset key 206 is selected at step S400, microcomputer 7 may recognize that a user intends to select a radio channel using frequencies stored in EEPROM 6. Accordingly, microcomputer 7 may read out information on stored radio frequencies from EEPROM 6 (step S410). Information on radio frequencies may be at least one of a frequency list according to the number of selection, a frequency list of a specified number of frequencies predetermined by a user, and information on a selected frequency. One of ordinary skill in the art may appreciate that other applications may be also possible.

Microcomputer 7 may control display device 1 to sequentially and/or simultaneously display a plurality of frequencies stored in EEPROM 6 whenever a user selects preset key 206 (step S420). Microcomputer 7 may control display device 1 to display frequencies in an order of their frequency of use when a user selects a radio function. For a control operation, microcomputer 7 may store a frequency in use for each frequency in a specified region of EEPROM 6. If preset key 206 is selected, microcomputer 7 may control display device 1 to display corresponding frequencies in an order of their frequency of use.

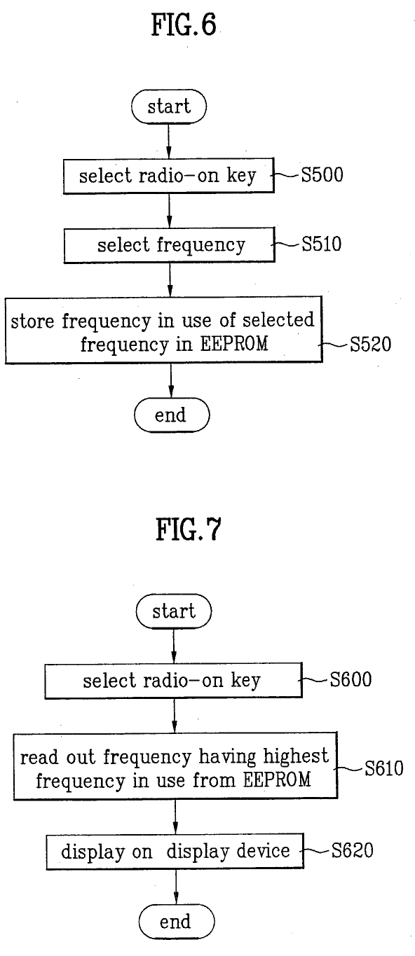

FIG. 6 is an exemplary flowchart illustrating a process of checking and storing a selection frequency of a selected frequency in a microwave oven according to embodiments of the present invention. Microcomputer 7 may, when a user selects a radio function (step S500) and/or selects a desired radio channel frequency (step S510), be controlled to store a frequency of use of a selected frequency in a specified region of EEPROM 6 (step S520). If frequency in use of a used frequency is stored as described above, it may be possible to control a display device to display frequencies stored in EEPROM 6 at step S420 in an order of their frequency of use.

FIG. 7 is an exemplary flowchart illustrating a control process so that use information of radio frequencies is displayed on a display device in a microwave oven according to embodiments of the present invention. Embodiments control display device 1 to display a radio frequency, whose frequency in use is largest, simultaneously with a selection of radio-on key 202. Microcomputer 7 may use a frequency of use of frequencies used according to an exemplary process of FIG. 6. Microcomputer 7 may monitor whether radio-on key 202 is selected. If radio-on key 202 is selected (step S600), microcomputer 7 may read out from EEPROM 6 a frequency whose frequency of use is largest based on frequencies in use stored in EEPROM 6 according to an exemplary process illustrated in FIG. 6 (step S610). A readout frequency may be displayed on display device 1 (step S620).

In embodiments of the present invention, a radio module may not operate while a cooking mode of the microwave oven is in operation. During a cooking operation, a magnetron may generate microwaves. Microwaves may prevent radio reception due to a high-frequency noise generated from a magnetron. Accordingly, if any radio-related key is selected during the operation of a microwave oven, an error sign may be displayed on display device 1 and/or an alarm may be generated indicating an error. If any button for a cooking control of a microwave oven is inputted while a radio function is performed, a message or an alarm may be output indicating that a radio function should be stopped. Information relating to selected radio channel frequencies may be stored in EEPROM 6. If preset key 206 is selected, information on channel frequencies stored in EEPROM 6 may be sequentially and/or simultaneously displayed on display device 1. Accordingly, a user may easily select a radio channel frequency.

Embodiments of the present invention enable radio listening using a microwave oven by providing a radio function in the microwave oven. A user may enjoy radio listening without separately purchasing a radio set. Various electric elements may be commonly provided in microwave oven that may be used for both control of a cooking function and a radio function. Accordingly, usability of electric elements provided in a microwave oven may be heightened. Embodiments of the present invention may provide a multi-functional electronic appliance. Accordingly, a user's satisfaction may become heightened.

Embodiments of the present invention are directed to a radio microwave oven and a radio listening method using the same that substantially obviates one or more problems due to limitations and disadvantages of the related art. An object of embodiments of the present invention is to provide a radio microwave oven and a radio listening method using the same that enable listening of a radio signal by adding simple components. An object of embodiments of the present invention is to provide a radio microwave oven and a radio listening method using the same that has a key input circuit for heightening convenience in use in the microwave oven that can receive the radio signal.

In embodiments, a radio microwave oven includes a microwave oven provided with a cooking control function, an input means for inputting a radio operation signal, a display means for displaying a radio operation state according to a signal from the input means, a radio module for tuning using a phase locked loop (PLL) system so as to receive a radio channel signal selected by a user without noise, a microcomputer for controlling the microwave oven, the radio module according to the signal from the input means, and the display means so as to display a signal from the radio module on the display means, and generating frequency selection information by monitoring the signal from the input means, and an electrically erasable and programmable read only memory (EEPROM) for storing the frequency selection information.

In embodiments, a radio listening method uses a microwave oven simultaneously implementing a radio function and a cooking function, includes the steps of selecting one of the radio function and the cooking function, uploading and displaying in a specified manner the pre-stored frequency selection information if the radio function is selected, selecting one frequency from the displayed frequency information, and listening to a desired radio broadcast by tuning with the selected frequency.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. An apparatus comprising an oven and a radio.

2. The apparatus of claim 1, wherein the oven is a microwave oven.

3. The apparatus of claim 1, comprising a controller, wherein the controller controls the oven and the radio.

4. The apparatus of claim 3, wherein the controller controls a frequency selection of the radio.

5. The apparatus of claim 4, wherein:
the radio comprises a radio frequency oscillator coupled to the controller;
the radio comprises a frequency divider coupled to the controller; and
the controller controls the frequency selection of the radio by controlling the radio frequency oscillator and the frequency divider.

6. The apparatus of claim 3, wherein:
the oven comprises a magnetron; and
the controller control an amount of power supplied to the magnetron.

7. The apparatus of claim 3, wherein the controller is a microcomputer.

8. The apparatus of claim 3, wherein the controller is coupled to a display and a user input.

9. The apparatus of claim 8, wherein:
the controller is configured to cause the display to output information related to operation of at least one of the oven and the radio; and
the controller is configured to receive a user input signal related to operation of at least one of the oven and the radio.

10. The apparatus of claim 8, wherein the controller is configured to cease operation of the radio while the oven is activated.

11. The apparatus of claim 10, wherein the controller is configured to output an indication on the display that the radio has ceased operation because the oven is activated.

12. The apparatus of claim 3, wherein:
the radio comprises an intermediate frequency circuit, a multiplexer circuit, and an universal counter; and
at least one of the intermediate frequency circuit, the multiplexer circuit, and the universal counter are coupled to the controller.

13. A method comprising ceasing operation of a radio when an oven is activated.

14. The method of claim 13, comprising outputting a message to a user indicating that the operation of the radio is ceased.

15. The method of claim 13, wherein the oven is a microwave oven.

16. The method of claim 13, wherein a controller controls the oven and the radio.

17. The method of claim 16, wherein the controller controls a frequency selection of the radio.

18. The method of claim 17, wherein:
the radio comprises a radio frequency oscillator coupled to the controller;
the radio comprises a frequency divider coupled to the controller; and
the controller controls the frequency selection of the radio by controlling the radio frequency oscillator and the frequency divider.

19. The method of claim 16, wherein:
the oven comprises a magnetron; and
the controller control an amount of power supplied to the magnetron.

20. The method of claim 16, wherein the controller is a microcomputer.

21. The method of claim 16, wherein the controller is coupled to a display and a user input.

22. The method of claim 21, wherein:
the controller is configured to cause the display to output information related to operation of at least one of the oven and the radio; and
the controller is configured to receive a user input signal related to operation of at least one of the oven and the radio.

23. The method of claim 21, wherein the controller is configured to cease operation of the radio while the oven is activated.

24. The method of claim 23, wherein the controller is configured to output an indication on the display that the radio has ceased operation because the oven is activated.

25. The method of claim 16, wherein:
the radio comprises an intermediate frequency circuit, a multiplexer circuit, and an universal counter; and
at least one of the intermediate frequency circuit, the multiplexer circuit, and the universal counter are coupled to the controller.

26. A radio microwave oven comprising:
a microwave oven driving module for controlling a cooking operation; and
a radio module for receiving a radio signal under the control of the microwave oven driving module.

27. The radio microwave oven of claim 26, wherein the microwave oven driving module and the radio module operate in a selective manner.

28. The radio microwave oven of claim 26, wherein the radio module comprises:
a frequency tuning section for tuning to a frequency corresponding to a channel selected by a user; and
a counter for numerating the frequency of the received radio signal.

29. The radio microwave oven of claim 28, wherein the frequency tuning section tunes to a desired frequency using a phase locked loop (PLL).

30. The radio microwave oven of claim 28, wherein the frequency tuning section comprises:
a frequency oscillator for oscillating a center frequency of a desired frequency according to a first external control signal;
a divider for dividing the frequency previously oscillated and inputted according to a second external control signal;
a phase comparator for comparing phases of an output of the divider and an output of the frequency oscillator;
a low pass filter for outputting a voltage corresponding to a phase difference between the two outputs;
a voltage adjustment section for outputting an oscillation frequency corresponding to the voltage from the low pass filter; and
a mixer for converting the received frequency into an intermediate frequency using the oscillation frequency outputted from the voltage adjustment section.

31. The radio microwave oven of claim 30, wherein the frequency oscillator and the divider start their operations according to the first and second external control signals, respectively.

32. The radio microwave oven of claim 31, wherein the first and second external control signals are applied from the microwave oven driving module.

33. The radio microwave oven of claim 30, wherein the frequency oscillator and the divider divide and oscillate a desired frequency according to the first and second external control signals, respectively.

34. The radio microwave oven of claim 33, wherein the first and second external control signals are applied from the microwave oven driving module.

35. The radio microwave oven of claim 30, wherein operations of the divider, the frequency oscillator, the phase comparator, the low pass filter, and the voltage adjustment section are repeatedly performed until the output of the divider coincides with the output of the frequency oscillator.

36. The radio microwave oven of claim 28, wherein the radio module further comprises:
an intermediate frequency circuit for amplifying a desired band signal from the output of the frequency tuning section;
a multiplexer circuit for converting an output of the intermediate frequency circuit into a stereo sound to output the stereo sound; and
a speaker for amplifying and outputting the stereo sound outputted from the multiplexer circuit.

37. The radio microwave oven of claim 36, wherein the microwave oven driving module receives and compares the outputs of the intermediate frequency circuit and the multiplexer circuit, and controls the radio module according to a result of comparison and the corresponding frequency of the channel selected by the user.

38. The radio microwave oven of claim 26, wherein the microwave oven driving module comprises:
a microcomputer for controlling selective driving of the microwave oven driving module and the radio module, and generating frequency selection information according to use of the radio module; and
a storage section for storing the use information.

39. The radio microwave oven of claim 38, wherein the storage section is implemented by an electrically erasable and programmable read only memory (EEPROM).

40. The radio microwave oven of claim 38, wherein the use information is at least one of a frequency candidate group composed of a predetermined number of frequencies according to a user's determination, frequencies recently used, and a frequency candidate group composed of a predetermined number of frequencies according to the frequency in selection.

41. The radio microwave oven of claim 38, wherein the microwave oven driving module further comprises:
an input means, connected to the microcomputer, for inputting data for the operation of the microwave oven driving module and the radio module; and
a display means, connected to the microcomputer, for displaying operation states of the microwave oven driving module and the radio module under the control of the microcomputer.

42. The radio microwave oven of claim 41, wherein the input means comprises:
a plurality of input keys for the cooking;
a preset key for selecting one among the frequency candidates according to the frequency selection information during an initial operation of the radio module;
a tuning key for fine tuning of the frequency corresponding to the channel subject to listening;
a band key for rough adjustment of the frequency corresponding to the channel subject to listening; and
a memory key for storing the frequency selection information according to a user's selection in the storage section.

43. The radio microwave oven of claim 41, wherein the input section further comprises:
an on/off key for turning on/off the radio module; and
a volume key for a volume adjustment during driving the radio module.

44. The radio microwave oven of claim 41, wherein the display means sequentially and/or simultaneously displays the frequency candidate groups according to the frequency selection information during an initial operation of the radio module.

45. The radio microwave oven of claim 38, wherein the microwave oven driving module further comprises:
a power supply section, connected to the microcomputer, for supplying a driving voltage of the radio microwave oven; and
a relay driving section for connecting/intercepting the power supply section for the operation of the microwave oven driving module.

46. The radio microwave oven of claim 38, wherein the radio module and the microcomputer perform a serial communication with each other.

47. A radio microwave oven comprising:
a microwave oven provided with a cooking control function;
an input means for inputting a radio operation signal;
a display means for displaying a radio operation state according to a signal from the input means;
a radio module for tuning using a phase locked loop (PLL) so as to receive a radio channel signal selected by a user without noise;
a microcomputer for controlling the microwave oven, the radio module according to the signal from the input means, and the display means so as to display a signal from the radio module on the display means, and generating frequency selection information by monitoring the signal from the input means; and
an electrically erasable and programmable read only memory (EEPROM) for storing the frequency selection information.

48. A radio listening method using a microwave oven simultaneously implementing a radio function and a cooking function, the method comprising:
selecting one of the radio function and the cooking function;
uploading and displaying in a specified manner the pre-stored frequency selection information if the radio function is selected;
selecting one frequency from the displayed frequency information; and
listening to a desired radio broadcast by tuning with the selected frequency.

49. The radio listening method of claim 48, further comprising:
continuously monitoring the selecting the frequency; and
generating the finally used frequency or a frequency candidate group composed of a predetermined number of frequencies whose frequency in selection is high as the frequency selection information with reference to a result of monitoring.

50. The radio listening method of claim 48, wherein the display in the specified manner is one of a display of the most recently selected frequency and sequential and/or simultaneous display of the frequency candidate group composed of a predetermined number of frequencies whose frequency in selection is high.
